(19) United States
(12) Patent Application Publication
(10) Pub. No.: US 2026/0135116 A1
(43) Pub. Date: May 14, 2026

(54) CURRENT COLLECTORS COMPRISING METALLISED MULTI-LAYER FILMS

(71) Applicant: DuPont Teijin Films U.S. Limited Partnership, Wilmington, DE (US)

(72) Inventors: Stephen Sankey, Wilton (GB); Lucien Schosseler, Luxembourg (LU); Stephen Jones, Wilton (GB); Pedro Nunes, Luxembourg (LU)

(73) Assignee: DuPont Teijin Films U.S. Limited Partnership, Wilmington, DE (US)

(21) Appl. No.: 18/705,734

(22) PCT Filed: Nov. 3, 2022
(86) PCT No.: PCT/GB2022/052767

§ 371 Date: Apr. 29, 2024

(30) Foreign Application Priority Data
Nov. 3, 2021 (GB) 2115792.0

(51) Int. Cl. H01M 4/66; B32B 7/027; B32B 27/08; B32B 27/36

(52) U.S. Cl. CPC H01M 4/667; B32B 7/027; B32B 27/08; B32B 27/36; H01M 4/661; B32B 2255/10; B32B 2255/205; B32B 2307/202; B32B 2307/31; B32B 2307/518; B32B 2307/7376; B32B 2457/10

(57) ABSTRACT

A current collector comprising a multi-layer film and a first metal layer, wherein the multi-layer film comprises a polyester substrate layer (B) having a first and second surface, a first heat-scalable layer (A1) disposed on the first surface of said polyester substrate layer and optionally a second heat-scalable layer (A2) disposed on the second surface of said polyester substrate layer. The first metal layer is disposed on the outer surface of the first heat-scalable layer (A1), the multi-layer film has a thickness of no more than 12 μm, and the first metal layer has a thickness of no more than 1000 nm.

This invention relates to polyester films for use in a current collector, to current collectors and other articles made therefrom, and to methods for their manufacture. In particular, the present invention is concerned with current collectors for use in batteries, particularly lithium-ion batteries.

Lithium-ion batteries are widely used in the field of rechargeable batteries which is set to continually grow over the foreseeable future due, in part, to the increasing demand for consumer electronics and storage of renewable energy. During battery operation (i.e. during charging and discharging), lithium ions are transferred between the anode material and the cathode material. Commercially available lithium-ion batteries typically contain metal foil current collectors, wherein a metal foil is placed in contact with each of the active solid electrodes. Generally, an aluminium-based foil is used as the cathode current collector and is disposed in contact with the cathode, whereas a copper-based foil is used as the anode current collector and is disposed in contact with the anode. In some arrangements, the cathode material may be coated on the cathode current collector and/or the anode material may be coated on the anode current collector.

However, there are problems with such existing metal foil current collectors. Firstly, the metal foil current collectors have a high conductivity which can contribute to an excessive current flow throughout the battery, leading to short-circuiting and over-heating thermal run-away, which can result in fires. Secondly, the metal foil current collectors are relatively thick, dense and heavy (typically having a thickness of over 12 μm) and hence contribute significantly to the overall mass of the battery. It would be desirable to provide current collectors which are thinner and/or lighter, in order to increase the energy density and minimise the size and mass of the batteries. However, it is challenging to provide a current collector which is thinner without detrimentally affecting its mechanical strength.

To that end, metallised polymeric film current collectors have been developed. Such current collectors contain an insulating or dielectric polymeric substrate layer and conductive metal layer(s) on the surface(s) thereof. As is known in the art, such current collectors act as an electrochemical fuse which breaks at pre-determined thermal and/or electrical loads in order to avoid excessive current flow and thermal run-away. The metal layer is typically formed by a metal deposition process, which may require multiple deposition steps. During said metal deposition process, and during subsequent fabrication of the battery, the current collector (and the polymeric substrate layer within the current collector) is exposed to conditions of elevated temperature for extended times, which can lead to film overheating and permanent film damage such as deformations and wrinkles and consequently to loss of adhesion between the metal layer and the polymeric substrate layer. This is a particular issue for thin current collectors.

It is an object of the invention to address one or more of the aforementioned problems. In particular, it is an object of the present invention to provide improved current collectors for use in batteries, preferably for use in a lithium-ion battery. It is a particular object of the invention to provide current collectors which are thin and which also exhibit improved adhesion between the polyester layer(s) and the metal layer(s), particularly following exposure to elevated temperature for extended time periods, for instance during manufacture, subsequent fabrication steps and/or end-use. It is also a particular object of the invention to provide current collectors which at least maintain, and preferably improve, the energy density of existing metal foil current collectors.

According to a first aspect of the invention, there is provided a current collector comprising a multi-layer film and a first metal layer, wherein the multi-layer film comprises:
(i) a polyester substrate layer (B) having a first and second surface,
(ii) a first heat-sealable layer (A1) disposed on the first surface of said polyester substrate layer,
(iii) optionally a second heat-sealable layer (A2) disposed on the second surface of said polyester substrate layer;
wherein said first metal layer is disposed on the outer surface of the first heat-sealable layer (A1), wherein the multi-layer film has a thickness of no more than 12 μm, and wherein the first metal layer has a thickness of no more than 1000 nm.

Preferably, the current collector further comprises a second metal layer, wherein the first metal layer and the second metal layer are on opposing sides of the multi-layer film, and wherein the layer order is first metal layer/multi-layer film/second metal layer. Where present, the second metal layer has a thickness of no more than 1000 nm.

The present inventors have unexpectedly found that such a current collector is advantageously thin whilst exhibiting excellent delamination resistance between the multi-layer film and the first metal layer and, where present, the second metal layer, following prolonged exposure to elevated temperatures. In particular, the present inventors have unexpectedly found that the bond which is formed by the thin heat-sealable layer(s) on the polyester substrate layer is sufficiently strong that excellent adhesion to both the polyester substrate layer and the metal layer is retained, even following prolonged exposure to elevated temperatures. This is particularly advantageous in the field of lithium-ion batteries which, during manufacture and in use, are liable to be subjected to such conditions.

The first metal layer and, where present, the second metal layer are the outermost layers of the current collector.

Thus, the current collector comprises at least three layers. Preferably, first heat-sealable layer (A1) is disposed directly on a first surface of the polyester substrate layer (B) and first metal layer is disposed directly on the opposite surface of the first heat-sealable layer, such that the layer order is first metal layer/first heat-sealable layer (A1)/polyester substrate layer (B). Thus, in this preferred embodiment, there are no intervening layers between the first metal layer and the first heat-sealable layer, and between the first heat-sealable layer and the polyester substrate layer respectively, such that the current collector consists of three layers.

Preferably, the current collector comprises at least four layers. Preferably, first heat-sealable layer (A1) is disposed directly on a first surface of the polyester substrate layer (B), second heat-sealable layer (A2) is disposed directly on a second surface of the polyester substrate layer (B), and first metal layer is disposed directly on the opposite surface of the first heat-sealable layer, such that the layer order is first metal layer/first heat-sealable layer (A1)/polyester substrate layer (B)/second heat-sealable layer (A2). In this preferred embodiment, there are no intervening layers between the first metal layer and the first heat-sealable layer, between the first heat-sealable layer and the polyester substrate layer, and between the second heat-sealable layer and the polyester substrate layer respectively, such that the current collector consists of four layers.

Alternatively, first heat-sealable layer (A1) is disposed directly on a first surface of the polyester substrate layer (B), first metal layer is disposed directly on the opposite surface of the first heat-sealable layer, and second metal layer is disposed directly on a second surface of the polyester substrate layer (B), such that the layer order is first metal layer/first heat-sealable layer (A1)/polyester substrate layer (B)/second metal layer. In this preferred embodiment, there are no intervening layers between the first metal layer and the first heat-sealable layer, between the first heat-sealable layer and the polyester substrate layer, and between the polyester substrate layer and the second metal layer respectively, such that the current collector consists of four layers.

Most preferably, the current collector comprises at least five layers. Preferably, first heat-sealable layer (A1) is disposed directly on a first surface of the polyester substrate layer (B), second heat-sealable layer (A2) is disposed directly on a second surface of the polyester substrate layer (B), first metal layer is disposed directly on the opposite surface of the first heat-sealable layer, and second metal layer is disposed directly on the opposite surface of the second heat-sealable layer (A2). Thus, the layer order is first metal layer/first heat-sealable layer (A1)/polyester substrate layer (B)/second heat-sealable layer (A2)/second metal layer. In this preferred embodiment, there are no intervening layers between the first metal layer and the first heat-sealable layer, between the first heat-sealable layer and the polyester substrate layer, between the polyester substrate layer and the second heat-sealable layer, and between the second heat-sealable layer and the second metal layer respectively, such that the current collector consists of five layers.

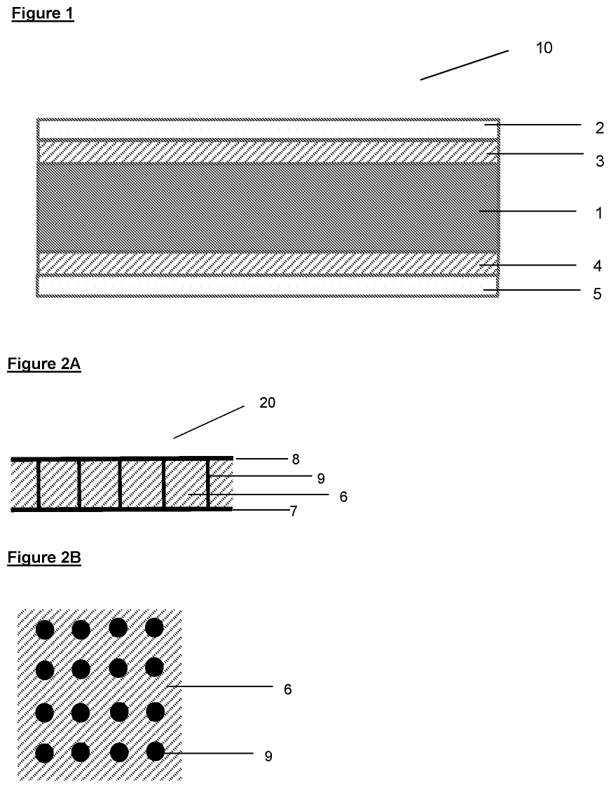

Such a current collector is further illustrated in FIG. 1. FIG. 1 shows, in cross section, current collector (10) comprising first metal layer (5), first heat-sealable layer (A1) (4), polyester substrate layer (B) (1), second heat-sealable layer (A2) (3) and second metal layer (2).

The substrate layer is a self-supporting film, by which is meant a film capable of independent existence in the absence of a supporting base.

Thermoplastic polyester materials, particularly linear polyesters, are preferred.

The term polyester as used herein refers to a homopolyester or copolyester derived from one or more diols at least one of which is an aliphatic diol, and one or more dicarboxylic acids at least one of which is an aromatic dicarboxylic acid. Suitable dicarboxylic acids include terephthalic acid, isophthalic acid, phthalic acid, 2,5-, 2,6- or 2,7-naphthalenedicarboxylic acid, succinic acid, sebacic acid, adipic acid, azelaic acid, 4,4′-diphenyldicarboxylic acid, hexahydro-terephthalic acid or 1,2-bis-p-carboxyphenoxyethane (optionally with a monocarboxylic acid, such as pivalic acid). Suitable diols include aliphatic diols and cycloaliphatic diols, such as ethylene glycol, 1,3-propanediol, 1,4-butanediol, neopentyl glycol and 1,4-cyclohexanedimethanol. Preferably, the aromatic dicarboxylic acid is selected from terephthalic acid and 2,5-, 2,6- or 2,7-naphthalenedicarboxylic acid, preferably from terephthalic acid and 2,6-naphthalenedicarboxylic acid. Preferably, the aliphatic diol is ethylene glycol. Preferably the polyester is a homopolyester. Preferably the polyester is polyethylene terephthalate (PET) or polyethylene naphthalate (PEN).

The preferred polyethylene terephthalate (PET) and polyethylene naphthalate (PEN) polyesters may optionally comprise, as one or more comonomer(s), relatively minor amounts (preferably less than 10% by weight or less than 5% by weight) of one or more residues derived from other dicarboxylic acids and/or diols. Other dicarboxylic acids include isophthalic acid, phthalic acid, 1,4-, 2,5-, or 2,7-naphthalenedicarboxylic acid, 4,4′-diphenyldicarboxylic acid, hexahydroterephthalic acid, 1,10-decanedicarboxylic acid and aliphatic dicarboxylic acids of the general formula CₙH₂ₙ(COOH)₂ wherein n is 2 to 8, such as succinic acid, glutaric acid sebacic acid, adipic acid, azelaic acid, suberic acid or pimelic acid. Other diols include aliphatic and cycloaliphatic glycols, such as diethylene glycol, propylene glycol, dipropylene glycol, 1,3-propanediol, 1,4-butane diol and 1,4-cyclohexanedimethanol. Preferably the polyester contains only one dicarboxylic acid, i.e. terephthalic acid or 2,6-naphthalene dicarboxylic acid, preferably terephthalic acid. Preferably the polyester contains only one diol, i.e. ethylene glycol.

Preferably, the substrate layer is a PET film or a PEN film.

The polyester is the major component of the polyester substrate layer, and makes up at least 60%, preferably at least 70%, and preferably at least 80% by weight of the total weight of the substrate layer. For example, the polyester may make up at least 85%, at least 90%, or at least 95% by weight of the total weight of the substrate layer.

The substrate layer may further comprise any other additive conventionally employed in the manufacture of polymer films. Such conventional additives may be present in minor proportion, typically no more than 35%, typically no more than 20%, typically no more than 5%, typically no more than 2% by weight relative to the total weight of the layer. Thus, agents such as particulate fillers, hydrolysis stabilisers, anti-oxidants, UV-stabilisers, cross-linking agents, dyes, lubricants, radical scavengers, thermal stabilisers, surface active agents, slip aids, anti-blocking agents, flame retardants, gloss improvers, prodegradents, viscosity modifiers and dispersion stabilisers may be incorporated as appropriate. Of particular utility are particulate fillers in order to improve handling and windability during manufacture, as is well known in the art. The particulate filler is typically a particulate inorganic filler (e.g. calcium carbonate, clays, silica, zeolites, silicone beads (such as functionalized polydimethyl siloxanes), dicalcium phosphates, tricalcium phosphates, cenospheres, zeospheres, talc, titanium dioxides, barium sulfate and barium titanate). Filler particle size distributions can be monomodal, bimodal and trimodal. Preferably, the volume-weighted mean particle diameter (D (4.3) is in the range from 0.1 to 10 μm for a monomodal, bimodal and trimodal distribution. Preferably, the filler particle size distribution is bimodal, such that there are two maximum peaks. Preferably, the first maxima of particles has a volume-weighted mean particle diameter (D_{(4,3)}) of about 0.5±0.3 μm and the second maxima of particles has a volume-weight mean particle diameter (D_{(4,3)}) of about 1.5±0.5 μm. Particle size of the filler particles is suitably measured by laser light diffraction. Particulate inorganic fillers are present in relatively minor amounts, typically less than 5.0 wt %, typically less than 2.0 wt %, typically less than 1.0 wt %.

Formation of the polyester is readily achieved by conventional synthetic methods well-known in the art. For example, a polyester may be made by a first step of direct esterification or trans-esterification, followed by a second step of polycondensation. Preferably, the synthetic procedure further comprises a solid phase polymerisation (SSP) step to increase the molecular weight of the polyester, as is well known in the art. Suitable solid phase polymerisation techniques are disclosed in, for example, EP-A-0419400 the disclosure of which is incorporated herein by reference. Thus, SSP is typically conducted at a temperature which is 10-50° C. below the crystalline melting point (T_{M}) of the polyester but higher than the glass transition temperature (T_{g}) (or where the polyester exhibits multiple glass transition temperatures, higher than the highest glass transition temperature). An inert atmosphere of dry nitrogen or a vacuum is used to prevent degradation. In a preferred embodiment, solid phase polymerisation is carried out over 16 hours at 220° C. under vacuum.

The inherent viscosity of a polyester suitable for use in the present invention is at least 0.5 dL/g, preferably at least 0.55 dL/g, preferably at least 0.6 dL/g, preferably at least 0.7 dL/g, preferably at least 0.8 dL/g.

The substrate layer is a monolayer film.

The thickness of the substrate layer is no more than 12 μm, preferably no more than about 11.0 μm, preferably no more than about 10.0 μm, preferably no more than about 7.0 μm, preferably no more than about 6.0 μm. The thickness of the substrate layer is preferably at least about 2.0 μm, preferably at least about 3.0 μm, preferably at least about 4.0 μm. Thus, the thickness of the substrate layer is preferably from about 2.0 to about 11.0 μm, preferably from about 2.0 to about 10.0 μm, preferably from about 3.0 to about 7.0 μm, preferably from about 4.0 to about 6.0 μm.

The thickness of the substrate layer is generally greater than the thickness of each of the first (A1) and second (A2) heat-sealable layers.

The thickness of the substrate layer is preferably at least about 50%, preferably at least about 60%, preferably at least about 70%, preferably at least about 75%, preferably at least about 80%, and preferably no more than about 99%, preferably no more than about 98%, preferably no more than about 95%, preferably no more than about 90%, and preferably about 85% of the total thickness of the multi-layer film.

The first heat-sealable layer (A1) and, where present, the second heat-sealable layer (A2) comprise heat-sealable material. The heat-sealable material should soften to a sufficient extent that viscosity becomes low enough to allow adequate wetting for it to adhere to the surface(s) to which it is being bonded.

The heat-sealable layer(s) may be formed from any polymeric material suitable as a heat-sealable layer on a polyester substrate.

In a first embodiment, the first heat-sealable layer and, where present, the second heat-sealable layer independently comprise at least one copolyester, hereinafter referred to as Embodiment A.

Preferably, the copolyester is derived from at least one aliphatic diol and at least two dicarboxylic acids. Preferably, the copolyester is derived from an aliphatic diol, a first dicarboxylic acid and a second dicarboxylic acid, wherein the second dicarboxylic acid is different to the first dicarboxylic acid. The aliphatic diol, first dicarboxylic acid and second dicarboxylic acid may be selected from those recited hereinabove.

In one preferred embodiment, hereinafter referred to as Embodiment A1, the heat-sealable layer comprises a copolyester derived from an aliphatic diol, a first aromatic dicarboxylic acid and a second aromatic dicarboxylic acid, wherein the second aromatic dicarboxylic acid is different to the first aromatic dicarboxylic acid. Preferably, the dicarboxylic acids are terephthalic acid and one other aromatic dicarboxylic acid, and preferably isophthalic acid. Thus, a preferred copolyester is derived from ethylene glycol, terephthalic acid and isophthalic acid.

The concentration of the second aromatic dicarboxylic acid (preferably isophthalic acid) is preferably in the range of from about 1 to about 50 mol %, preferably from about 10 to about 45 mol % of the acid fraction of the copolyester. Particularly preferred concentrations of the second aromatic dicarboxylic acid (preferably isophthalic acid) are in the range of (i) from about 15 to about 20 mol %, preferably about 18 mol % of the acid fraction of the copolyester; (ii) from about 10 to about 15 mol %, preferably about 12 mol % of the acid fraction of the copolyester; or (iii) from about 30 to about 45 mol %, preferably about 40 mol % of the acid fraction of the copolyester.

In an alternative preferred embodiment, hereinafter referred to as Embodiment A2, the heat-sealable layer comprises a copolyester derived from an aliphatic diol, an aromatic dicarboxylic acid and an aliphatic dicarboxylic acid. Preferably, the aromatic dicarboxylic acid is terephthalic acid and the aliphatic dicarboxylic acid is selected from succinic acid, sebacic acid, adipic acid and azelaic acid, preferably azelaic acid. Thus, a preferred copolyester is derived from ethylene glycol, terephthalic acid and azelaic acid.

The concentration of the aliphatic dicarboxylic acid (preferably azelaic acid) is preferably in the range of from about 10 to about 50 mol %, preferably from about 30 to about 48 mol %, preferably about 45 mol % of the acid fraction of the copolyester.

In an alternative preferred embodiment, hereinafter referred to as Embodiment A3, the heat-sealable layer comprises a copolyester derived from an aliphatic diol, a cycloaliphatic diol and at least one dicarboxylic acid, preferably an aromatic dicarboxylic acid. Examples include copolyesters of terephthalic acid with an aliphatic diol and a cycloaliphatic diol, especially ethylene glycol and 1,4-cyclohexanedimethanol.

The concentration of the cycloaliphatic diol (preferably 1,4-cyclohexanedimethanol) is preferably in the range of from about 10 to about 60 mol %, preferably from about 20 to about 40 mol %, preferably from about 30 to about 35 mol %, preferably about 33 mol % of the diol fraction of the copolyester.

Preferably, the copolyester is a copolyester of terephthalic acid with about 33 mol % of 1,4-cyclohexanedimethanol and about 67 mol % ethylene glycol. An example of such a copolyester is PETG™6763 (Eastman). In an alternative embodiment, the copolyester may comprise butanediol in place of ethylene glycol.

In an alternative preferred embodiment, hereinafter referred to as Embodiment A4, the heat-sealable layer comprises a copolyester derived from one or more diols, one or more dicarboxylic acids and one or more poly(alkylene oxide)glycols. The diols and dicarboxylic acids are selected from those recited hereinabove. Preferably the diol used is an aliphatic diol, most preferably ethylene glycol.

In one preferred embodiment, the dicarboxylic acid used is an aromatic dicarboxylic acid, most preferably terephthalic acid. In an alternative preferred embodiment, a first dicarboxylic acid and a second dicarboxylic acid are used, wherein the second dicarboxylic acid is different to the first dicarboxylic acid. Preferably, the first dicarboxylic acid is a first aromatic dicarboxylic acid and the second dicarboxylic acid is a second aromatic dicarboxylic acid (which is different to the first aromatic dicarboxylic acid). Preferably, the first dicarboxylic acid is terephthalic acid and the second aromatic dicarboxylic acid is isophthalic acid. Thus, a preferred copolyester is derived from ethylene glycol, terephthalic acid, isophthalic acid and one or more poly(alkylene oxide)glycols. Particularly preferred concentrations of the second aromatic dicarboxylic (preferably isophthalic acid) are in the range of (i) from about 15 to about 20 mol %, preferably about 18 mol % of the acid fraction of the copolyester; (ii) from about 10 to about 15 mol %, preferably about 12 mol % of the acid fraction of the copolyester; or (iii) from about 30 to about 45 mol %, preferably about 40 mol % of the acid fraction of the copolyester. Concentration (ii) is particularly preferred.

Suitable poly(alkylene oxide)glycols for the copolyester of Embodiment A4 are preferably selected from poly(alkylene oxide)glycols having C₂ to C₁₅, more preferably C₂ to C₁₀, and more preferably C₂ to C₆ alkylene chains. The poly(alkylene oxide)glycol is preferably selected from polyethylene glycol (PEG), polypropylene glycol (PPG) and poly(tetramethylene oxide)glycol (PTMO), and most preferably is polyethylene glycol. Ethylene oxide-terminated poly(propylene oxide) segments may also be used. Mixtures of poly(alkylene oxide)glycols can be used, but in a preferred embodiment the copolyester comprises only one type of poly(alkylene oxide)glycol.

The number average molecular weight (Mn) of the poly(alkylene oxide)glycol is preferably from about 100 g/mol to about 20000 g/mol, preferably from about 200 g/mol to about 6000 g/mol, preferably from about 200 g/mol to about 5000 g/mol, preferably no more than about 5000 g/mol, preferably no more than about 4000 g/mol, preferably from about 200 g/mol to about 3500 g/mol, preferably at least about 200 g/mol, preferably from about 200 g/mol to about 3000 g/mol, preferably from about 250 g/mol to about 1500 g/mol, preferably from about 275 g/mol to about 700 g/mol, preferably from about 300 g/mol to about 500 g/mol, preferably from about 350 g/mol to about 450 g/mol, and preferably about 400 g/mol. The number average molecular weight (Mn) of the poly(alkylene oxide) is preferably at least about 200 g/mol, preferably at least about 250 g/mol, preferably at least about 275 g/mol, preferably at least about 300 g/mol, for example at least about 350 g/mol. The number average molecular weight (Mn) of the poly(alkylene oxide) is preferably no more than about 20000 g/mol, preferably no more than about 5000 g/mol, preferably no more than about 1500 g/mol, preferably no more than about 500 g/mol, for example no more than about 450 g/mol.

Thus, in a preferred embodiment, the copolyester comprises and preferably consists of repeating units derived from an aliphatic diol (preferably ethylene glycol), an aromatic dicarboxylic acid (preferably terephthalic acid) and a poly(alkylene oxide)glycol (preferably PPG and/or PEG, preferably PEG). In an alternative preferred embodiment, the copolyester comprises and preferably consists of repeating units derived from an aliphatic diol (preferably ethylene glycol), a first aromatic dicarboxylic acid (preferably terephthalic acid), a second dicarboxylic acid (preferably a second aromatic dicarboxylic acid, preferably isophthalic acid) and a poly(alkylene oxide)glycol (preferably PPG and/or PEG, preferably PEG).

The poly(alkylene oxide)glycol preferably constitutes from about 0.1 to about 70 wt %, preferably from about 0.5 to about 65 wt %, preferably from about 1 to about 60 wt %, preferably from about 2 to about 50 wt %, preferably from about 5 to about 30 wt %, preferably from about 10 to about 20 wt %, preferably from about 10 to about 15 wt %, and preferably about 12 wt % relative to the total weight of the copolyester.

Formation of the copolyesters is conveniently effected in known manners by condensation or ester-interchange, as discussed hereinabove, at temperatures generally up to 275° C.

In a second embodiment, the first heat-sealable layer and, where present, the second heat-sealable layer are independently a heat-sealable polymeric layer, hereinafter referred to as Embodiment B. The heat-sealable polymeric layer may be formed from any polymeric material suitable as a heat-sealable layer on a polyester substrate. Suitable heat-sealable polymeric materials include polyvinylidene chloride (PVDC) and ethylene vinyl acetate (EVA). EVA is particularly preferred.

Suitable EVA polymers for the heat-sealable layer include the EVA polymers commercially available as Elvax™ resins (DuPont) or those commercially available as Ateva® resins (Celanese). Typically, the EVA resin has a vinyl acetate content in the range of 5% to 50%, preferably 9% to 40%, and typically 15% to 30%.

The heat-sealable layer preferably comprises the EVA copolymer in an amount of from 20 to 98 wt % by total weight of the heat-sealable layer. Preferably, the heat-sealable layer comprises a blend of two or more EVA copolymers, wherein two or more of the EVA copolymers have a different VA content. Where the heat-sealable layer comprises a blend of two or more EVA copolymers, the preferred total amount of EVA copolymer is the same as described above. Optional components include styrenic linear block copolymer thermoplastic elastomers (for instance those disclosed in WO-2021/171190-A, the disclosure of which elastomers is incorporated herein by reference), and such components are typically present in amounts of about 10 to 50 wt %. Further optional components include tackifying resins (for instance those disclosed in WO-2021/171190-A, the disclosure of which resins is incorporated herein by reference), and such components are typically present in amounts of about 15 to 50 wt %. Further optional components include slip-aid(s) or anti-blocking agent(s) which improve the handling of the film, as is conventional in the art of sealant coatings, and such components are present in relatively minor amounts, typically no more than 5.0 wt %, typically no more than 2.0 wt %. Suitable slip-aids include Carnauba wax, kemamide, talc (such as those available from Specialty Minerals under the tradename Talcron MP 15-38) and silica (such as Syloid® 620, Syloid® 244).

PVDC polymers for the heat-sealable layer of Embodiment B are well known in the art, and suitable PVDC materials for the heat-sealable layer are copolymers of vinylidene chloride with other monomers. A vinylidene chloride copolymer is typically obtained as a latex dispersed in a medium by polymerizing using conventional emulsion polymerization methods 50 to 99% by mass of vinylidene chloride as a starting material and 1 to 50% by mass of one or more other monomers copolymerizable with vinylidene chloride. The higher the proportion of vinylidene chloride, the higher the crystalline melting point of the vinylidene chloride copolymers. Examples of the copolymerizable monomer include: vinyl chloride; acrylic acid esters such as methyl acrylate, ethyl acrylate, butyl acrylate, 2-ethylhexyl acrylate and 2-hydroxyethyl acrylate; methacrylic acid esters such as methyl methacrylate and glycidyl methacrylate; acrylonitrile and methacrylonitrile; and unsaturated carboxylic acids such as acrylic acid, methacrylic acid, itaconic acid and maleic acid. One or two or more of such monomers may be used. The solid content concentration of the vinylidene chloride copolymer mixture latex can be appropriately altered according to the specifications of the coating apparatus or the drying-heating apparatus, and is preferably in a range from 10 to 70% by mass and more preferably in a range from 30 to 55% by mass.

In a third embodiment, the first heat-sealable layer and, where present, the second heat-sealable layer are independently a coated layer comprising a first copolyester hereinafter referred to as Embodiment C. Preferably, the first copolyester is derived from one or more diol(s) and two or more dicarboxylic acid(s).

Thus, in one preferred embodiment, hereinafter referred to as Embodiment C1, the coated layer comprises the first copolyester. Embodiment C1 does not comprise a second copolyester.

In another preferred embodiment, hereinafter referred to as Embodiment C2, the coated layer comprises the first copolyester and a second copolyester, wherein each of the first and second copolyesters are independently derived from one or more diol(s) and two or more dicarboxylic acid(s). In embodiment C2, at least one of the comonomers in one of the first and second copolyesters imparts heat-sealability (as defined herein) to the heat-sealable coating layer (C).

Preferably, the first copolyester in Embodiment C (i.e. in Embodiment C1 and C2) is derived from an aliphatic glycol (preferably ethylene glycol), a first aromatic dicarboxylic acid (preferably terephthalic acid) and a second aliphatic dicarboxylic acid (preferably azelaic acid). Suitable copolyesters included those recited hereinabove for Embodiment A, particularly Embodiment A2.

Preferably, the first copolyester in Embodiment C is derived from ethylene glycol, terephthalic acid and azelaic acid. In the first copolyester, the preferred molar ratio of the first dicarboxylic acid (preferably terephthalic acid) to the second dicarboxylic acid (preferably azelaic acid) is in the range of from 50:50 to 90:10, preferably in the range from 52:48 to 70:30, and is preferably about 55:45.

Preferably, the second copolyester in Embodiment C2 is derived from an aliphatic glycol (preferably ethylene glycol), a first aromatic dicarboxylic acid (preferably terephthalic acid) and a second aromatic dicarboxylic acid (preferably isophthalic acid). Suitable copolyesters included those recited hereinabove for Embodiment A, particularly Embodiment A1. Preferably, the second copolyester in Embodiment C2 is derived from ethylene glycol, terephthalic acid and isophthalic acid. In the second copolyester, the preferred molar ratio of the first dicarboxylic acid (preferably terephthalic acid) to the second dicarboxylic acid (preferably isophthalic acid) is in the range of from 50:50 to 90:10, preferably in the range from 55:45 to 70:30, and is preferably about 60:40.

In a fourth embodiment, the first heat-sealable layer and, where present, the second heat-sealable layer are independently a layer comprising a cross-linked sulfopolyester, hereinafter referred to as Embodiment D.

In Embodiment D, the heat-sealable layer comprises a cross-linked sulfopolyester. Thus, preferably the heat-sealable layer is derived from a composition comprising a crosslinking agent and a sulfopolyester.

Suitable crosslinking agents include melamines, isocyanates, oxazolines, aziridines, carbodiimides, epoxy resins, silanes and zirconium based crosslinking agents. The crosslinking agent is preferably a melamine crosslinking agent. Suitable melamine crosslinking agents for use in the present invention may be selected from those available from Cytec under the tradename Cymel®, such as Cymel® XW 3106 and Cymel® 350, preferably Cymel® XW 350. Cymel® XW 3106 is a water insoluble, specifically alkylated high solids melamine resin. Cymel® 350 is a water soluble, highly methylated monomer melamine resin.

Suitable sulfopolyesters comprise and preferably consist of monomeric units derived from one or more diol(s), one or more dicarboxylic acid(s) and one or more sulfomonomers. The description and preferences of the one or more diol(s) and the one or more dicarboxylic acid(s) described above are equally applicable to the sulfopolyester of Embodiment D.

Preferably, the sulfomonomers are selected from sulfonated aromatic dicarboxylic acids in which a sulfonate group is attached to the aromatic nucleus. Preferably, the sulfonate group of such a sulfomonomer is a sulfonic acid salt, preferably a sulfonic acid salt of a Group I or Group II metal, preferably lithium, sodium or potassium, more preferably sodium. Ammonium salts may also be used. The sulfonated aromatic dicarboxylic acid may be selected from any suitable aromatic dicarboxylic acid, e.g. terephthalic acid, isophthalic acid, phthalic acid, 2,5-, 2,6- or 2,7-naphthalenedicarboxylic acid. However, preferably the aromatic dicarboxylic acid of the sulfomonomer is isophthalic acid. Preferred sulfomonomers are 5-sodium sulfo-isophthalic acid and 4-sodium sulfo-isophthalic acid.

Suitable sulfopolyesters for Embodiment D may be selected from those available from Eastman under the tradename Eastek™ 1200. Eastek™ 1200 is an aqueous dispersion of a sulfopolyester derived from 5-sodium sulfo-isophthalic acid, supplied as an aqueous solution containing 2% n-propanol and 30 wt % solids.

The composition of Embodiment D may comprise any of the additives conventionally used, such as catalysts, surfactants, anti-blocking agents and slip aids.

The composition of Embodiment D may further comprise minor amounts of conventional acidic or basic catalysts, such as alkali metal carboxylates and quaternary ammonium halides. Example of suitable catalysts include ammonium p-toluenesulfonic acid (APTSA) and ammonium nitrate.

The mass percentage ratio in the dry heat-sealable layer of Embodiment D of sulfopolyester/crosslinking agent is preferably from about 100/1 to about 100/50, preferably from about 100/10 to about 100/20. The mass percentage ratio in the dry heat-sealable layer of crosslinking agent/catalyst is preferably from about 100/1 to about 5/1, preferably from about 30/1 to about 5/1, preferably about 10/1. Thus, such catalysts are typically present in the range of from about 1% to about 20% by weight, preferably from about 3% to about 18%, preferably from about 5% to about 15%, preferably about 10% by weight based on the weight of the crosslinking agent in the dry heat-sealable layer.

The composition of Embodiment D may further comprise minor amounts of conventional surfactants, such as polysorbate 20. An example of a suitable surfactant is Tween® 20, available from Sigma Aldrich. Tween® 20 is a polyoxyethylene sorbitol ester.

Such surfactants are typically present in an amount of no more than about 1.0%, typically no more than about 0.5%, for example about 0.2% by weight based on the total solids content of the composition of Embodiment D.

The total thickness of the heat-sealable layers (i.e. the thickness of the first heat-sealable layer (A1) where the second heat-sealable layer (A2) is absent, or the total thickness of the first heat-sealable layer (A1) and the second heat-sealable layer (A2) where the second heat-sealable layer (A2) is present) is preferably no more than about 50%, preferably no more than about 40%, preferably no more than about 30%, preferably no more than about 25%, preferably no more than about 20%, and preferably at least about 1%, preferably at least about 10%, and preferably about 15% of the total thickness of the multi-layer film.

The thickness of the first heat-sealable layer (A1) and, where present, the thickness of the second heat-sealable layer (A2) is preferably each independently from about 0.1 to about 3.5 μm, preferably from about 0.2 to about 3.0 μm, preferably from about 0.5 to about 2.0 μm, preferably from about 0.6 to about 1.5 μm, and preferably from about 0.7 to about 1.0 μm.

The total thickness of the multi-layer film is preferably from about 3.0 to 12 μm, preferably from about 3.5 to about 11.0 μm, preferably from about 4.0 to about 8.0 μm.

The multi-layer film is preferably uniaxially or biaxially oriented, preferably biaxially oriented.

In a preferred embodiment, the multi-layer film is a coextruded film, preferably according to Embodiment A described herein.

In an alternative preferred embodiment, the multi-layer film is a coated film, preferably according to Embodiments B, C and D described herein.

Preferably, the multi-layer film exhibits an adhesion strength to itself of at least about 100 g/25 mm², preferably at least about 200 g/25 mm², preferably at least about 275 g/25 mm², preferably at least about 500 g/25 mm².

Advantageously, the multi-layer film may be and preferably is manufactured in air, i.e, wherein the film is not manufactured (including the steps of extrusion, casting and stretching) under the atmosphere of an inert gas (such as nitrogen or a noble gas such as argon). Thus, the compositions and films described herein are thermally stable, and do not require any special handling conditions, in particular an inert atmosphere, during manufacture or storage.

Formation of the multi-layer film may be effected by conventional techniques well-known in the art. The method of formation of the multi-layer film will depend on the identity of the heat-sealable layer(s). Conventional techniques include casting or coating the heat-sealable layer(s) onto a preformed polyester substrate layer. Conveniently, formation of the heat-sealable layer and the substrate layer is effected by coextrusion, and this is particularly suitable for Embodiment A described herein. Other methods of forming the multi-layer substrate include forming the substrate layer and then coating the heat-sealable material onto the substrate layer, and this technique is particularly suitable for Embodiments B, C and D described herein.

Where both the first heat-sealable layer (A1) and the second heat-sealable layer (A2) are present, a combination of techniques may be employed. For example, the first heat-sealable layer (A1) and the substrate layer may be effected by coextrusion and the second heat-sealable layer (A2) may be coated. Alternatively, the second heat-sealable layer (A2) and the substrate layer may be effected by coextrusion and the first heat-sealable layer (A1) may be coated. However, it is preferred that the first heat-sealable layer (A1) and the second heat-sealable layer (A2) are each effected by the same technique, i.e. each by coextrusion or each by coating.

Thus, formation of the substrate layer and/or the coextruded multi-layer films may be effected by conventional extrusion techniques well-known in the art. In general terms, the process comprises the steps of extruding a layer of molten polymer at a temperature within a range appropriate to the melting temperature of the polymer, for instance in a range of from about 270 to about 300° C. (or, typically, no more than about 15° C., preferably no more than about 10° C., higher than the crystalline melting point of the polymer), and then rapidly quenching the extrudate to ensure that the polymer is quenched to the amorphous state. The quenched extrudate is then biaxially oriented by stretching in two mutually perpendicular directions in the plane of the film at a temperature above the glass transition temperature(s) of the polymer to achieve a satisfactory combination of mechanical and physical properties. Biaxial orientation may be achieved by sequential or simultaneous biaxial orientation. In the present invention, the films are advantageously manufactured by simultaneous biaxial orientation, for instance in a tubular process, by extruding a thermoplastic polymer tube which is subsequently quenched, reheated and then expanded by internal gas pressure to induce transverse orientation, and withdrawn at a rate which will induce longitudinal orientation. Particularly suitable simultaneous biaxial orientation processes are disclosed in EP-2108673-A and US-2009/0117362-A1, the disclosure of which processes is incorporated herein by reference.

Stretching is generally effected so that the dimension of the oriented film is from 2 to 7, preferably from 2 to 5, more preferably 2.5 to 4.5, more preferably 3.0 to 4.5, more preferably 3.0 to 4.0 times its original dimension in each direction of stretching. Preferably, the film is stretched from 3.2 to 3.6 times its original dimension in the machine direction (MD) and preferably from 3.3 to 3.8 times its original dimension in the transverse direction (TD). Stretching is effected at temperatures higher than the T_{g} of the polymer composition, preferably at least about 5° C. higher, preferably at least about 15° C. higher than the T_{g}, and preferably in the range of from about T_{g}+5° C. to about T_{g}+75° C., preferably from about T_{g}+5° C. to about T_{g}+30° C. Where the polymer composition is PET, stretching is typically effected at temperatures in the range of about 85 to about 110° C., preferably about 95 to about 100° C. Where the polymer composition is PEN, stretching is typically effected at temperatures in the range of about 130 to about 155° C., preferably about 140 to about 145° C. It is not necessary to stretch equally in the machine and transverse directions although this is preferred if balanced properties are desired.

The stretched film may then be dimensionally stabilised. In a first step, the film is annealed under dimensional support (or restraint) to induce the desired crystallinity of the polymer. A temperature of at least about 200° C. is preferred. Preferably, the temperature used is above the glass transition temperature(s) of the polyester of the substrate layer but below the melting temperature (T_{M}) thereof. Within these constraints, preferred annealing temperatures are typically from about 40° C. less than the melting temperature of the substrate layer (i.e. T_{M}−40° C.) to about 10° C. less than T_{M} (i.e. T_{M}−10° C.), preferably about T_{M}−30° C. Where the film is a multi-layer film, the temperature used is also preferably above, or at, the melting temperature (T_{M(HS)}) of the heat-sealable material of the heat-sealable layer(s). Within these constraints, preferred annealing temperatures are typically from about 25° C. more than the melting temperature of the heat-sealable layer(s) (i.e. T_{M(HS)}+15° C.) to about 5° C. more than the melting temperature of the heat-sealable layer(s) (i.e. T_{M(HS)}+5° C.), preferably about T_{M(HS)}+10° C. Thus, the annealing temperature will depend on the polymer compositions used. For example, where the heat-sealable layer(s) comprise a copolyester derived from ethylene glycol, terephthalic acid and isophthalic acid, where the isophthalic acid is about 18 mol % of the acid fraction of the copolyester, then the annealing temperature is suitably in the range of from about 200 to about 245° C., preferably from about 215 to about 235° C. The time at which the film is held at this temperature is preferably in the range of 0 to 60 seconds, preferably 0.1 to 10 seconds, preferably 0.5 to 5 seconds, preferably 0.7 to 3 seconds.

After annealing under dimensional restraint, the films may then be subjected to dimensional relaxation, preferably simultaneous dimensional relaxation, in both the transverse direction (TD) and machine direction (MD). The relaxation step is suitably an in-line relaxation step, i.e. a stage in the film manufacturing line. The relaxation of the film is preferably from about 0.5 to about 5.0%, preferably from about 1.0 to about 4.0%, preferably from about 1.0 to 3.0%, preferably from about 1.0 to about 2.0%, in each of the transverse direction (TD) and machine direction (MD). In the relaxation step, the film is heated at a temperature which is preferably no higher than that of the immediately preceding annealing step, and with a lower MD and TD tension. MD relaxation is controlled by reducing the speed of the film line, while TD relaxation is controlled by reducing the distance between the film clamps on opposing lateral edges of the film, each of which results in a decrease in the tension experienced by the film in the relevant dimension at this stage of manufacture. A temperature of at least about 200° C. is preferred, preferably from about 200° C. to about 240° C., preferably from about 210° C. to about 230° C., preferably from about 215° C. to about 230° C., preferably from about 215° C. to 225° C. The duration of heating of the relaxation step will depend on the temperature used but is typically in the range of 0 to 30 seconds, preferably 0.1 to 10 seconds, preferably 0.4 to 4 seconds, preferably 0.9 to 3.8 seconds.

Preferably a second relaxation step is then conducted (in which case the relaxation step described above is referred to as the first relaxation step). The second relaxation step is effected in a similar way to that described for the first relaxation step. A temperature of at least about 195° C. is preferred, and a temperature of at least about 200° C. is most preferred. Preferably, the second relaxation step may be effected at a similar temperature to the first relaxation step. Alternatively, the second relaxation step may be conducted at a lower temperature than the first relaxation step, typically to about 20° C. less than the first relaxation step. The duration of heating of the second relaxation step will depend on the temperature used but is typically in the range of 0 to 30 seconds, preferably 0.1 to 10 seconds, preferably 0.4 to 3.5 seconds, preferably 0.7 to 3.0 seconds.

After the annealing step and relaxation step(s), the film may be rapidly cooled.

Where the heat-sealable layer(s) is instead coated onto the substrate layer, coating may be effected using any suitable coating technique, including gravure roll coating, reverse roll coating, dip coating, bead coating, extrusion coating, melt coating or electrostatic spray coating. Coating may be, and preferably is, conducted “off-line”, i.e. after stretching and any subsequent dimensional stabilization employed during manufacture of the polyester substrate, or “in-line”, i.e, wherein the coating step takes place before, during or between any stretching operation(s) employed. When coating is performed in-line, it is preferably performed between the forward and sideways stretches of a biaxial stretching operation (“inter-draw” coating).

Where the first heat-sealable layer (A1) and/or the second heat-sealable layer (A2) are coated and are according to Embodiment C, the composition from which the heat-sealable coating layer is derived preferably comprises at least about 1% by weight, preferably at least about 5% by weight, preferably at least about 10% by weight, and preferably at least about 12% by weight of the first copolyester based on the total weight of the composition prior to drying. Preferably, the composition from which the heat-sealable coating layer is derived comprises no more than about 20% by weight, preferably no more than about 18% by weight, preferably no more than about 16% by weight, preferably no more than about 15% by weight, and preferably no more than about 14% by weight of the first copolyester based on the total weight of the composition prior to drying.

Thus, preferably the composition from which the heat-sealable coating layer according to Embodiment C is derived comprises in the range of from about 1% to about 20% by weight, preferably from about 5% to about 18% by weight, preferably from about 10% to about 16% by weight, preferably from about 10% to about 15% by weight, and preferably from about 12% to about 14% by weight of the first copolyester based on the total weight of the composition prior to drying.

Where the first heat-sealable layer (A1) and/or the second heat-sealable layer (A2) are coated and are according to Embodiment C2, the composition from which the heat-sealable coating layer is derived preferably comprises at least about 0.1% by weight, preferably at least about 0.5% by weight, preferably at least about 1% by weight, preferably at least about 2% by weight and preferably at least about 3% by weight of the second copolyester based on the total weight of the composition prior to drying. Preferably, the composition from which the heat-sealable coating layer is derived comprises no more than about 10% by weight, preferably no more than about 8% by weight, preferably no more than about 6% by weight, preferably no more than about 5% by weight and preferably no more than about 4% by weight of the second copolyester based on the total weight of the composition prior to drying.

Thus, preferably the composition from which the heat-sealable coating layer of Embodiment C2 is derived comprises in the range of from about 0.1% to about 10% by weight, preferably from about 0.5% to about 8% by weight, preferably from about 1% to about 6% by weight, preferably from about 2% to about 5% by weight, and preferably from about 3% to about 4% by weight of the second copolyester based on the total weight of the composition prior to drying.

The heat-sealable coating layer of Embodiment C may also comprise a slip-aid or anti-blocking agent which improves the handling of the film, as is conventional in the art of sealant coatings. Suitable slip-aids or anti-blocking agents for the heat-sealable coating layer of the present invention may be selected from those available from PMC Biogenix under the tradename Kemamide EZ, which is a fatty amide slip-aid and/or from those available from Grace under the tradename Sylobloc®, such as Sylobloc 48. Such components are present in relatively minor amounts, typically no more than 5.0 wt %, typically no more than 2.0 wt %, typically no more than 1.0 wt % based on the total weight of the composition prior to drying.

The heat-sealable coating layer of Embodiment C may also comprise particulate filler material. The particulate filler is preferably a particulate inorganic filler, for example metal or metalloid oxides, such as alumina, titania, talc (such as those available from Specialty Minerals under the tradename Talcron MP 15-38) and silica (especially precipitated or diatomaceous silica and silica gels), calcined china clay and alkaline metal salts (such as the carbonates and sulphates of calcium and barium). Any inorganic filler present should be finely-divided, and the volume distributed median particle diameter (equivalent spherical diameter corresponding to 50% of the volume of all the particles, read on the cumulative distribution curve relating volume % to the diameter of the particles-often referred to as the “D(v,0.5)” value) thereof is preferably in the range from 0.01 to 5 μm, more preferably 0.05 to 1.5 μm, and particularly 0.15 to 1.2 μm. Preferably at least 90%, more preferably at least 95% by volume of the inorganic filler particles are within the range of the volume distributed median particle diameter ±0.8 μm, and particularly ±0.5 μm. Particle size of the filler particles may be measured by electron microscope, coulter counter, sedimentation analysis and static or dynamic light scattering. Techniques based on laser light diffraction are preferred. The median particle size may be determined by plotting a cumulative distribution curve representing the percentage of particle volume below chosen particle sizes and measuring the 50th percentile. Such components are present in relatively minor amounts, typically no more than 5.0 wt %, typically no more than 4.0 wt %, typically no more than 3.0 wt % relative to the total weight of the composition prior to drying.

The composition from which the heat-sealable coating layer of Embodiment C is derived suitably comprises a first copolyester, optionally a second copolyester (i.e. in Embodiment C2) and a coating vehicle. Typically, the first and second copolyester (where present) are dispersed or dissolved in the coating vehicle. The coating vehicle can be any suitable coating vehicle, particularly tetrahydrofuran (THF) or a combination of tetrahydrofuran (THF) and toluene. Where the coating vehicle comprises THF and toluene, the weight ratio of THF to toluene is preferably in the range of from 70:30 to 90:10, preferably about 80:20.

The composition from which the heat-sealable coating layer of Embodiment C is derived preferably comprises the coating vehicle in an amount such that the composition has a solids content of 5 to 30%, preferably 8% to 25%, preferably 10 to 20%, and preferably 15% to 19% by weight relative to the total weight of the composition.

It will be appreciated that the first copolyester and, where present, the second copolyester, slip-aid agent, anti-blocking agent and/or particular filler material typically make up the solids content of the composition from the heat-sealable coating layer. Preferably, the first copolyester and second copolyester together make up at least about 85% by weight, preferably at least about 90% by weight, preferably at least about 93% by weight, preferably at least about 95% by weight of the solids content of the composition from which the heat-sealable coating is derived.

In Embodiment C1, the first copolyester preferably makes up at least about 85% by weight, preferably at least about 90% by weight, preferably at least about 93% by weight, preferably at least about 95% by weight of the solids content of the composition from which the heat-sealable coating layer is derived.

In Embodiment C2, the first copolyester preferably makes up at least about 70% by weight, preferably at least about 73% by weight, preferably at least about 75% by weight of the solids content of the composition from which the heat-sealable coating is derived. Preferably, the second copolyester makes up at least 15% by weight, preferably at least about 17% by weight, preferably at least about 18% by weight of the solids content of the composition from which the heat-sealable coating is derived.

Where the first heat-sealable layer (A1) and/or the second heat-sealable layer (A2) are coated and are according to Embodiment D, preferably the composition from which the heat-sealable layer is derived comprises at least about 0.1% by weight, preferably at least about 0.2% by weight, preferably at least about 0.5% by weight of the crosslinking agent based on the total weight of the composition prior to drying. Preferably, the composition from which the heat-sealable layer is derived comprises no more than about 3% by weight, preferably no more than about 2% by weight, preferably no more than about 1.5% by weight of the crosslinking agent based on the total weight of the composition prior to drying.

Thus, preferably the composition from which the heat-sealable layer of Embodiment D is derived comprises in the range of from about 0.1% to about 3% by weight, preferably from about 0.2% to about 2%, preferably from about 0.5% to about 1.5% by weight of the crosslinking agent based on the total weight of the composition prior to drying. Typically, the composition from which the heat-sealable layer of Embodiment D is derived comprises about 0.53% by weight of the crosslinking agent based on the total weight of the composition prior to drying.

Preferably the composition from which the heat-sealable layer of Embodiment D is derived comprises at least about 0.5% by weight, preferably at least about 1% by weight, preferably at least about 2% by weight, preferably at least about 4% by weight of the sulfopolyester based on the total weight of the composition prior to drying. Preferably, the composition from which the heat-sealable layer of Embodiment D is derived comprises no more than about 20% by weight, preferably no more than about 15% by weight, preferably no more than about 10% by weight, preferably no more than about 8% by weight of the sulfopolyester based on the total weight of the composition prior to drying.

Thus, preferably the composition from which the heat-sealable layer of Embodiment D is derived comprises in the range of from about 0.5% to about 20% by weight, preferably from about 1% to about 15%, preferably from about 2% to about 10%, preferably from about 4% to about 8% by weight of the sulfopolyester based on the total weight of the composition prior to drying. Typically, the composition from which the heat-sealable layer of Embodiment D is derived comprises about 6% by weight of the sulfopolyester based on the total weight of the composition prior to drying.

The coating composition from which the heat-sealable layer of Embodiment D is derived suitably comprises a crosslinking agent, a sulfopolyester and a coating vehicle. Typically, the crosslinking agent and sulfopolyester are dispersed or dissolved in the coating vehicle. The coating vehicle can be any suitable coating vehicle, particularly an aqueous coating vehicle. The coating composition preferably comprises the coating vehicle in an amount such that the composition has a solids content of 1 to 15%, preferably 3% to 12%, preferably 4 to 10%, preferably 5 to 8%, preferably 6% to 7% by weight relative to the total weight of the composition.

The resulting multi-layer film preferably exhibits high dimensional stability at elevated temperatures and positive thermal expansion at 200° C. in each of the transverse direction (TD) and the machine direction (MD). The thermal response of the multi-layer film in each of the machine and transverse directions is therefore aligned with that of the metal layer(s), and the current collectors exhibit high dimensional stability, without deformation, warping or delamination during subsequent processing at elevated temperatures (e.g. during metal deposition or during subsequent battery formation).

Preferably, the multi-layer film exhibits thermal expansion in air at 200° C. of from greater than 0% to no more than 3.0%, preferably from greater than 0% to no more than 2.0%, preferably from 0.1% to 2.0%, preferably from 0.2% to 1.5% in each of the transverse direction (TD) and in the machine direction (MD). Preferably, the multi-layer film exhibits isotropic thermal expansion, i.e. the layer expands by the same amount in the TD and in the MD.

The inventors have found that the manufacturing steps, particularly the annealing and relaxation process described herein, can be conducted such that the multi-layer film exhibits isotropic thermal expansion. In particular, the degree of dimensional relaxation in the MD and TD in the relaxation process described herein can be controlled. For example, the degree of dimensional relaxation effected in the MD and TD can be different in order to counteract any residual deformation in the MD or TD resulting from prior manufacturing steps, such that the final resulting film exhibits balanced properties and hence isotropic thermal expansion.

Preferably, the multi-layer film exhibits a positive coefficient of linear thermal expansion (CLTE) in air over the range of 32° C. to 200° C., preferably a positive CLTE of less than 20×10⁻⁵/° C., preferably a positive CLTE of less than 17×10⁻⁵/° C., preferably a positive CLTE of less than 10×10⁻⁵/° C., preferably a positive CLTE of less than 9×10⁻⁵/° C., preferably a positive CLTE of less than 8.5×10⁻⁵/° C. in each of the transverse direction (TD) and the machine direction (MD).

The first metal layer and, where present, the second metal layer are each formed from a metallic conductive material. Preferably, the first and second metal layers comprise the same metallic conductive material. Alternatively, the first and second metal layers may comprise different metallic conductive materials. The metallic conductive material is preferably selected from at least one of aluminium, copper, nickel, titanium, silver, nickel-copper alloy, or aluminium-zirconium alloy. Preferably, the metallic conductive material is aluminium or copper. Where the current collector is a cathode current collector, the first metal layer and, where present, the second metal layer preferably comprise aluminium. Where the current collector is an anode current collector, the first metal layer and, where present, the second metal layer preferably comprise copper.

Where the first metal layer and, where present, the second metal layer comprise aluminium, preferably the substrate layer is a PET film. Where the first metal layer and, where present, the second metal layer comprise copper, preferably the substrate layer is a PEN film.

The metal layer(s) preferably comprises at least 90%, preferably at least 95%, preferably at least 98% and preferably at least 99% by weight of the aforementioned metallic conductive material, the stated weights of metallic conductive material being the percent by weight relative to the total weight of the metal layer. In a preferred embodiment, the metal layer consists of metallic conductive material.

The metal layer(s) preferably exhibit positive thermal expansion coefficients. Preferably, the first metal layer and, where present, the second metal layer in the current collectors of the present invention independently exhibit thermal expansion in air at 200° C. of from greater than 0% to no more than 2.0%, preferably from greater than 0% to no more than 1.0%, preferably from 0.25% to 0.75%, preferably from 0.3 to 0.5%. Each of the metal layers in the current collectors of the present invention preferably exhibit isotropic thermal expansion, i.e. the layers expand by the same amount in orthogonal directions, for instance in the directions corresponding to the machine and transverse dimensions of the multi-layer film. Preferably the first metal layer and the second metal layer exhibit the same expansion at 200° C. as each other.

Preferably, the first metal layer and, where present, the second metal layer independently exhibits a positive coefficient of linear thermal expansion (CLTE) in air at 100° C. of from about 10×10⁻⁶/° C. to about 30×10⁻⁶/° C., preferably from about 12×10⁻⁶/° C. to about 18×10⁻⁶/° C.

Preferably, the thickness of each of the first metal layer and, where present, the second metal layer is independently in the range of from about 50 nm to about 1000 nm, preferably from about 100 nm to about 1000 nm, preferably from about 100 nm to about 800 nm, preferably from about 150 nm to about 700 nm.

Each of the first metal layer and, where present, the second metal layer are suitably deposited onto the multi-layer film. Any suitable deposition technique well-known in the art for the manufacture of metallized films may be used, including at least one of vapor deposition and electro-less plating. Preferably, the first and second metal layers are independently deposited onto the multi-layer film by at least one of vapor deposition and electro-less plating. The vapor deposition may be at least one of physical vapor deposition (PVD), virtual cathode deposition (VCD) or chemical vapor deposition (CVD).

Preferably, the physical vapor deposition is selected from at least one of evaporation deposition and sputtering deposition. The evaporation deposition is preferably at least one of vacuum evaporation, thermal evaporation, or electron beam evaporation techniques. The sputtering deposition is preferably magnetron sputtering. Suitable processes include, for instance, plasma-enhanced vapour deposition techniques, such as plasma-enhanced electron beam evaporation techniques, and plasma-enhanced sputtering techniques.

Preferably, thermal evaporation deposition, electron beam evaporation or virtual cathode deposition is used to dispose the metal layer(s).

Typically, thermal evaporation deposition comprises placing a multi-layer film and a source material within a vacuum chamber. The source material is heated under vacuum (preferably below 10-4 Pa) and high temperature until it evaporates. The evaporated source material particles disperse towards the substrate and condense at the substrate surface to form a thin film. Typically, a resistive coil in the form of a powder or solid bar is subjected to a large direct current (preferably in the range of 100 to 150 mA for a period of 10 to 15 seconds), which thus generates the heat used to evaporate the source material. Suitable apparatus includes those commercially available under the name “BAE 370” from Balzers AG (Liechtenstein), or equipment commercially available from Bühler and Applied Materials.

Typically, electron beam evaporation comprises evaporating a source material using high energy electrons in the form of an intense beam. A hot filament is used to thermionically emit electrons which are used, after acceleration, to evaporate the source material.

Typically, virtual cathode deposition comprises supplying a high voltage pulse to a virtual plasma cathode in order to generate a high energy density electron beam (preferably wherein the energy is greater than 100 MW/cm²). The high energy density electron beam ablates a solid target, such that a portion (e.g. about 0.001 mm³) of the ablated target material forms a plasma. The plasma propagates in the form of a plasma flume towards the polyester substrate. The plasma flume may have a velocity of up to about 50 km/s. The target material plasma condenses at the multi-layer film surface to form a thin film. For example, a thin film of up to 0.1 nm thickness may form per pulse at 400 cm². Repeating the high voltage pulses (e.g. up to a frequency of about 600 Hz) and/or using an apparatus comprising multiple virtual cathode groups allows the deposited film to grow until the desired thickness is reached. Suitable virtual cathode deposition methods and apparatus are known and include, for instance, the methods and apparatus as discussed in WO-2016/042530-A and in US-2020/0095129-A, and the disclosures of said methods and apparatus are incorporated herein by reference.

The deposition technique may require a single-pass or multiple-passes (such as a double-pass) in order to deposit a metal layer of the desired thickness. Preferably, the deposition technique requires a single-pass, which advantageously increases manufacturing efficiency and minimises the exposure of the multi-layer film to conditions of elevated temperature for extended time.

As will be appreciated by the skilled person, the current collector is required to exhibit electrical conductivity when disposed in the battery. Thus, conductivity must be allowed between the outer surfaces of the current collector despite the electrical insulation conferred by the multi-layer film. For example, conductivity must be allowed from the first metal layer to the second metal layer (where present), despite the electrical insulation conferred by the substrate layer, the first heat-sealable layer and, where present, the second heat-sealable layer positioned between the first and second metal layers.

In one embodiment, referred to herein as Arrangement 1, the current collector further comprises at least one conductive tab which connects the first metal layer and the second metal layer such that the current collector exhibits electrical conductivity from one surface to the other surface thereof. Such conductive tabs are known in the art, and disclosed for instance in WO-2019/051123-A and U.S. Pat. No. 10,700,339-B. Preferably, the tab extends beyond the periphery of the current collector, such that the tab is capable of connecting the current collector with other components within the battery. Preferably, the tab extends from the interior to the exterior of the lithium-ion battery, such that the tab is capable of connecting the battery to an external source.

In another embodiment, referred to herein as Arrangement 2, the multi-layer film comprises channels which extend from the first surface to the second, opposite surface thereof wherein (i) the sides of the channels are at least partially coated with at least one metal, and/or (ii) the channels are at least partially filled with at least one metal, preferably such as to generate conductive pathways between the first and second metal layers. Such channels are known in the art, and disclosed for instance in US-2019/0305320-A. The channels may have an aperture size (e.g. diameter) in the range of from about 1 μm to about 5 mm. The fraction of the surface area of the multi-layer film made up of channel apertures is typically from about 0.01 to about 10%. Such channels allow a further reduction in weight of the battery, as well as improving its electrochemical properties such as charge-discharge rates and cycle life. Said metal is preferably deposited during the metal deposition step(s) used to deposit the first and second metal layers described hereinabove, and preferably the virtual cathode deposition technique. Arrangement 2 is further illustrated in FIG. 2. FIG. 2A shows, in cross section, the current collector arrangement. The current collector (20) has a multi-layer film (6), a first metal layer (7) and a second metal layer (8), wherein the layer order is: first metal layer/multi-layer film/second metal layer. The multi-layer film (6) has multiple perforated holes which are filled with metal (9). The metal forms a continuous connection between the first metal layer and the second metal layer. FIG. 2B shows, in top view, the multi-layer film in the current collector arrangement.

Arrangement 1 and Arrangement 2 may be present in the same battery.

The total thickness of the current collector of the present invention is preferably from about 1 μm to about 12 μm, preferably from about 2 μm to about 8 μm and preferably from about 4 μm to about 8 μm, preferably from about 4 to about 6 μm.

Preferably, the current collector exhibits a sheet resistance no more than about 2.0 Ωsq⁻¹, preferably of no more than about 1.5 Ωsq⁻¹, preferably of no more than about 1.0 Ωsq⁻¹. Preferably, the current collector exhibits a sheet resistance of at least about 0.01 Ωsq⁻¹, preferably of at least about 0.02 Ωsq⁻¹, preferably of at least about 0.05 Ωsq⁻¹. Preferably the current collector exhibits a sheet resistance of from about 0.01 Ωsq⁻¹ to about 2.0 Ωsq⁻¹, preferably from about 0.02 Ωsq⁻¹ to about 2.0 Ωsq⁻¹, preferably from about 0.02 Ωsq⁻¹ to about 1.5 Ωsq⁻¹, preferably from about 0.05 Ωsq⁻¹ to about 1.0 Ωsq⁻¹.

Preferably, the current collector exhibits a breakdown current of no more than about 35 A, preferably no more than about 30 A, preferably no more than about 20 A, preferably no more than about 10A, preferably no more than about 5 A. Preferably, the current collector exhibits a breakdown temperature of no more than 300° C., preferably no more than about 250° C., preferably no more than about 240° C., preferably no more than about 230° C., and preferably no more than about 220° C. In a preferred embodiment, the breakdown temperature is no more than the crystalline melting point (T_{M}) of the polyester which makes up the major component of the substrate layer, and typically corresponds to the point at which the polyester layer starts to shrink. Thus, when the substrate layer is a PEN film, the current collector preferably exhibits a breakdown temperature of no more than about 270° C., preferably of no more than about 260° C., preferably of no more than about 250° C., preferably of no more than about 220° C. When the substrate layer is a PET film, the current collector preferably exhibits a breakdown temperature of no more than about 260° C., preferably of no more than about 250° C., preferably of no more than about 220° C. The breakdown current and temperature correspond to the points at which the current collector fails, i.e. the points at which the film acts as an electrochemical fuse to successfully prevent excessive current flow and risk of thermal propagation in the battery.

Preferably, the adhesion strength between a metal layer and the multi-layer film is at least about 250 g/25 mm, preferably at least about 280 g/25 mm, preferably at least about 300 g/25 mm.

Preferably, the delamination resistance of the multi-layer film is at least about 80%, preferably at least about 85%, preferably at least about 90%.

According to a second aspect of the present invention, there is provided a method of manufacturing a current collector as described herein, wherein the method comprises the steps of:
(i) providing a polyester substrate layer (B);
(ii) disposing a first heat-sealable layer (A1) onto the first surface of polyester substrate layer (B);
(iii) optionally disposing a second heat-sealable layer (A2) onto the second surface of polyester substrate layer (B);
(iv) depositing a metal onto the outer surface of said first heat-sealable layer (A1) to form a first metal layer;
   such that the layer order is first metal layer/first heat-sealable layer/polyester substrate layer/optional second heat-sealable layer.

Preferably, the method further comprises the step of:
(v) depositing a metal onto the second surface of polyester substrate layer (B) or, where present, onto the outer surface of said second heat-sealable layer (A2) to form a second metal layer;
   such that the layer order is first metal layer/first heat-sealable layer/polyester substrate layer/second metal layer, or first metal layer/first heat-sealable layer/polyester substrate layer/second heat-sealable layer/second metal layer.

As discussed hereinabove, steps (ii) and (iii) may independently be effected by coextrusion or coating. Steps (ii) and (iii) may be conducted separately and sequentially, or may be combined into a single technique.

Prior to application of a metal layer (steps (iv) and (v)), the exposed surface of the multi-layer film (e.g. the exposed surface of the polyester substrate and/or the exposed surface of the first or second heat-sealable layer) may, if desired, by subjected to a chemical or physical surface-modifying treatment to improve the bond between the multi-layer film and the subsequently applied metal layer. It is particularly advantageous to subject the exposed surface of the multi-layer film to such a treatment prior to deposition of the metal layer.

A preferred treatment is to subject the exposed surface of the multi-layer film to a plasma treatment. The plasma treatment comprises exposing the surface to discharge caused and maintained by imposing a high voltage in a low pressure gas atmosphere, that is, so-called glow discharge. The surface is treated with activated particles of electrons, ions, excited atoms, excited molecules, radicals, and ultraviolet rays formed during this glow discharge. One or more agents known in the art may be injected into the glow discharge and onto the substrate. The one or more agents may be deposited to form a coating on the exposed surface. Known agents include organic molecules, inorganic molecules and biomolecules. Preferred agents include a mixture of acrylic acid and methacrylic anhydride, (3-Glycidyloxypropyl) trimethoxysilane, N-(3-Trimethoxysilylpropyl) diethylenetriamine or (3-Mercaptopropyl) trimethoxysilane. For example, suitable mixtures of acrylic acid and methacrylic anhydride include mixtures comprising 75% by weight of acrylic acid and 25% by weight of methacrylic anhydride, or mixtures comprising 50% by weight of acrylic acid and 50% by weight of methacrylic anhydride.

A preferred plasma treatment is corona treatment (sometimes referred to as air plasma), in which the exposed surface of the multi-layer film is subjected to a high voltage electrical stress accompanied by corona discharge. The preferred treatment by corona discharge may be effected in air at atmospheric pressure with conventional equipment using a high frequency, high voltage generator, preferably having a power output of from 1 to 20 KW at a potential of 1 to 100 kV. Discharge is conventionally accomplished by passing the film over a dielectric support roller at the discharge station at a linear speed preferably of 1.0 to 500 m per minute. The discharge electrodes may be positioned 0.1 to 10.0 mm from the moving film surface.

Following plasma treatment, the exposed surface of the multi-layer film preferably exhibits a water contact angle of no more than about 70°, preferably of no more than about 65°, preferably of no more than about 60°. Following plasma treatment, the substrate layer preferably exhibits a water contact angle of at least about 5°, preferably of at least about 10°, preferably of at least about 14°. Preferably, following plasma treatment, the substrate layer exhibits a water contact angle of from about 5° to about 70°, preferably from about 10° to about 65°, preferably from about 14° to about 60°.

The water contact angle between a droplet of HPLC-grade water and the substrate layer may be measured with the Surface Analyst 3001 (BTG Labs).

Following plasma treatment, the multi-layer film preferably exhibits a surface energy of from about 30 mN/m to about 100 mN/m, preferably from about 30 to about 80 mN/m. The surface energy can be measured by an ink-based surface energy test, such as a Dyne level test following ISO 8296.

The description and preferences of the first aspect are equally applicable to the second aspect.

According to a third aspect of the invention, there is provided the use of a multi-layer film in a current collector which further comprises a first metal layer, wherein said use is for imparting improved adhesion strength and/or delamination resistance between said multi-layer film and metal layer, and wherein the multi-layer film comprises:
(i) a polyester substrate layer (B) having a first and second surface,
(ii) a first heat-sealable layer (A1) disposed on the first surface of said polyester substrate layer,
(iii) optionally a second heat-sealable layer (A2) disposed on the second surface of said polyester substrate layer;
   wherein said first metal layer is disposed on the outer surface of the first heat-sealable layer (A1), wherein the multi-layer film has a thickness of no more than 12 μm, and wherein the first metal layer has a thickness of no more than 1000 nm.

The description and preferences of the first and second aspects are equally applicable to the third aspect.

According to a fourth aspect of the invention, there is provided a battery comprising an anode material, an anode current collector, a cathode material, a cathode current collector and a separator situated between the anode material and the cathode material, wherein at least one of said current collectors is the current collector as described herein.

The battery may be selected from a lithium-ion battery, a lithium-sulfur (LiS) battery, a lithium-air (LiO₂) battery or a sodium-ion battery. Preferably, the battery is a lithium-ion battery, a lithium-sulfur (LiS) battery or a lithium-air (LiO₂) battery. Preferably, the battery is a lithium-ion battery. Preferably, the battery is a sodium-ion battery.

Any suitable anode material, cathode material and separator, as conventional in the art, may be used.

The anode material may be selected from graphite and/or lithium titanate (LTO).

The cathode material may be selected from lithium or mixed oxides of lithium and other metal(s), particularly lithium titanate (LTO), lithium iron phosphate (LiFePO₄, also known as LFP) and/or lithium-nickel-manganese-cobalt oxide (LiNiMnCoO₂, also known as NMC).

Preferred electrodes are disclosed in, for example, UK application no. 2115767.2, the disclosure of which is incorporated herein by reference. In particular, said electrode may be constituted by an active material and a binder material, wherein the binder material comprises a copolyester which comprises repeating units derived from a diol, a dicarboxylic acid and a poly(alkylene oxide). The binder material may further comprise a first metal ion-containing component selected from conductive ceramic particulate materials, and/or may further comprise additional metal ions from one or more sources other than said conductive ceramic particulate materials.

The separator may be a polymeric, ceramic, non-woven or fabric separator. Preferred separators are disclosed in, for example, WO-2019/186173-A1, WO-2021/064359-A1 and UK application no. 2110926.9, the disclosures of which are incorporated herein by reference. In particular, said separator may be a copolyester film comprising a copolyester which comprises repeating units derived from a diol, a dicarboxylic acid and a poly(alkylene oxide), wherein the copolyester film further comprises a first metal ion-containing component selected from conductive ceramic particulate materials, and wherein the film may further comprise additional metal ions from one or more sources other than said conductive ceramic particulate material.

Such preferred separators may be made by a method which comprises manufacturing the copolyester film, wherein said method comprises the steps of:
(i) reacting said diol with said dicarboxylic acid or an ester thereof (suitably a lower alkyl (C₁₋₄) ester, preferably the dimethyl ester), to form a bis(hydroxyalkyl)-ester of said dicarboxylic acid;
(ii) polymerising in a polycondensation reaction said bis(hydroxyalkyl)-ester of said dicarboxylic acid in the presence of an poly(alkylene oxide) to form a copolyester;
(iii) introducing said first metal ion-containing component selected from conductive ceramic particulate materials, and optionally said additional metal ions from one or more sources other than said conductive ceramic particulate materials, during synthesis of the copolyester in steps (i) and/or (ii), and/or during a subsequent separate compounding or mixing step, to form a copolyester composition; and
(iv) forming a copolyester film from said copolyester composition, preferably by melt-extruding said composition or by solvent-casting a dispersion or solution comprising said copolyester composition.

The separator may be synthesised according to the techniques disclosed in UK application no. 2110926.9, the disclosures of which are incorporated herein by reference.

It will be appreciated that the battery comprises an anode current collector and a cathode current collector, wherein at least one of said current collectors is the current collector as described herein. Preferably, both the anode current collector and cathode current collector are a current collector as described herein. Alternatively, one of the anode current collector and a cathode current collector is a current collector as described herein and the other current collector is any suitable current collector as conventional in the art. Preferred other current collectors are disclosed in, for example, UK application no. 2106834.1, the disclosure of which are incorporated herein by reference. In particular, said other current collector may be a current collector comprising a biaxially oriented polymeric substrate layer and a first metal layer on a side of the polymeric substrate layer, wherein the polymeric substrate layer exhibits positive thermal expansion in air at 200° C. in each of the transverse direction (TD) and machine direction (MD), wherein the polymeric substrate layer has a thickness of no more than 12 μm, and wherein the first metal layer has a thickness of no more than 1000 nm.

The battery (preferably the lithium-ion battery) may further comprise an electrolyte. Where present, the electrolyte is preferably a conductive organic solvent which may saturate the other materials present in the battery, thereby providing a mechanism for the ions to conduct between the anode and cathode.

Alternatively, the battery (preferably the lithium-ion battery) may be a dry-cell battery. The dry-cell battery contains a solid separator situated between the anode material and the cathode material, wherein the separator functions as both separator and electrolyte. As such, liquid electrolytes are eliminated.

In the embodiment of Arrangement 1, as described hereinabove, the current collector further comprises at least one conductive tab which connects the first metal layer and the second metal layer such that the current collector exhibits electrical conductivity from one surface to the other surface thereof. Preferably, the tab extends beyond the periphery of the current collector, such that the tab is capable of connecting the current collector with other components within the battery. Preferably, the tab extends from the interior to the exterior of the battery, such that the tab is capable of connecting the battery to an external source.

Preferably, the electrode material is coated or otherwise deposited onto the current collector.

The battery (preferably the lithium-ion battery) may have any configuration that is known in the art, including cans, pouch cells, prismatic cells, coin cells, cylindrical cells, wound prismatic cells and wound pouch cells.

The description and preferences of the first to third aspects are equally applicable to the fourth aspect.

According to a fifth aspect of the invention, there is provided the use of a current collector as described herein in a battery (preferably a lithium-ion battery) as described herein.

The description and preferences of the first to fourth aspects are equally applicable to the fifth aspect.

According to a sixth aspect of the invention, there is a provided a method of manufacturing a battery (preferably a lithium-ion battery) as described herein, the method comprising the steps of:
(i) preparing a current collector as described herein;
(ii) assembling the battery (preferably the lithium-ion battery), wherein the battery comprises an anode material, a cathode material, a separator between the anode material and the cathode material, an anode current collector and a cathode current collector, wherein at least one of said current collectors is the current collector obtained from step (i).

Preferably, the anode or cathode material may be coated or otherwise deposited onto the current collector described herein using any suitable coating or deposition technique conventional in the art for electrode preparation. It will be appreciated that the anode material is coated or otherwise deposited onto the outer surface of a metal layer of an anode current collector, whereas the cathode material is coated or otherwise deposited onto the outer surface of a metal layer of a cathode current collector. High processing temperatures (e.g. around 200° C.) are used during this coating or deposition step. In a preferred embodiment, the electrode material is coated onto the current collector.

The electrode/current collector assembly is suitably dried at a temperature of from about 50° C. to about 170° C., preferably from about 80° C. to 160° C. It will be appreciated that the drying step may comprise various different temperature zones comprising an appropriate heating profile.

The dried electrode/current collector assembly is preferably compacted, for instance by calendering between a rotating pair of rollers. During calendering, said assembly may be exposed to static discharge and cleaned, for example by brushes or air flow. Optionally, all or part of the compaction step may be heated, for instance by preheating sections and/or rollers in a calendering process, for example to temperatures of from about 50° C. to about 250° C.

The description and preferences of the first to fifth aspects are equally applicable to the sixth aspect.

This invention is further illustrated with reference to the figures, as described below.

FIG. 1 shows the assembly of a multi-layer film, as described hereinabove. FIG. 2 shows the assembly of a current collector according to Arrangement 2, as described hereinabove.

FIG. 2A shows, in cross section, the current collector. FIG. 2B shows, in top view, the multi-layer film in the current collector arrangement.

### Property Measurement

The following test methods were used to characterise the properties of the current collectors and batteries described herein.
(i) Glass transition temperature (T_{g}) and crystalline melting point (Tₘ) were measured by differential scanning calorimetry (DSC) using a Universal V4.5A machine (TA Instruments). Unless otherwise stated, measurements were made according to the following standard test method and based on the method described in ASTM E1356-98. The sample was maintained under an atmosphere of dry nitrogen for the duration of the scan (approx. 1.5 to 3 hours). The sample (about 7 mg) was heated from 20° C. to 250° C. at a rate of 20° C./min, held at 250° C. for 5 minutes, and then cooled to 20° C. at a rate of 20° C./min, and then heated from 20° C. to 250° C. at 10° C./min. The thermal properties were recorded on the second heating scan.

The value of T_{g} was taken as the extrapolated onset temperature of the glass transition observed on the DSC scan (heat flow (W/g) against temperature (C)), as described in ASTM E1356-98.

The value of Tₘ was taken from the DSC scan as the temperature at which peak heat flow was observed in the respective transition.

### (ii) Expansion of the Multi-Layer Film

A sample of the multi-layer film having dimensions of 5 mm×8 mm was subjected to thermomechanical analysis using a thermomechanical analyser (TMA Q400 by TA Instruments Inc.). The longer dimension of the sample (i.e. the 8 mm dimension) corresponds to the sample direction for which expansion was being tested. The sample was mounted on the apparatus and the sample was subjected in the machine direction (MD) or in the transverse direction (TD) to a load of 1 N/mm² and a temperature increase rate of 10° C./min from 32° C. to 220° C. The thermal expansion in air at a temperature of 200° C. was measured. The thermal expansion in air at 200° C. is defined as the % change of dimension of the film in the given direction (i.e. in the MD or TD), and calculated as (L₁−L₀)/L₀×100, where L₀ is the dimension at 32° C. and L₁ is the dimension at 200° C. As the skilled person will appreciate, a negative thermal expansion indicates thermal shrinkage.

(iii) Coefficient of Linear Thermal Expansion (CLTE)

A procedure similar to that of (ii) was used. For the coefficient of linear thermal expansion measurement (b), the CLTE values were derived from the formula:

$$CLTE = ( {L}_{1} - {L}_{0} ) / ( {L}_{0} \times ( {T}_{2} - {T}_{1} ) )$$

where (L₁-L₀) is the measured change in length of the sample over the temperature range (T₂−T₁), and L₀ is the original specimen length at 32° C. Suitably, T₂ was 200° C. and T₁ was 32° C. The data can be plotted as a function of the % change in specimen length with temperature, normalised to 32° C.

### (iv) Sheet Resistance

The sheet resistance of the conductive layer was measured using a linear four point probe (Jandel Model RM2) according to ASTM F390-98 (2003).

### (v) Breakdown Current and Temperature at Breakdown

A current collector sample having dimensions 50 mm×10 mm was held at each end between a pair of conducting clamps. The sample was clamped such that 10 mm² at each end of the sample was held within the clamps. A current was passed through the samples at a ramp rate of 2 A/min until breakdown was observed. The temperature profile of the sample was monitored using a thermal imaging camera throughout the test, in order to determine the temperature at breakdown.

### (vi) Adhesion Strength of the Multi-Layer Film to Itself

The adhesion (heat-seal) strength of the film to itself was measured, as follows. An A4 sample of the multi-layer film was prepared. Thus, a multi-layer film of the present invention comprising a polyester substrate layer (B) and at least one heat-sealable layer (A) was prepared. The multi-layer film was folded in the MD direction, such that the heat-sealable layer was in contact with itself. The sample was heat-sealed using a Sentinel Model 12 (Packaging Industries Group Inc.) machine under the following conditions: 140° C. (top jaw) and 40° C. (lower jaw) for 1 seconds under a pressure of 40 psi. The sealed sample was cut into 25 mm wide strips and the adhesion strength was determined using an Instron Model 4464. The jaws were set 50 mm apart. The upper jaw held one piece of the sealed sample and travelled up at a speed of 250 mm/min, while the lower jaw held the other piece of the sealed sample and was stationary. The force required to peel the two pieces of the sample at a 90° was measured and reported as a mean value of 13 results.

(vii) Adhesion Strength of the Current Collector

The adhesion strength of the metallised film to an EAA (ethylene acrylic acid film) having a thickness of 25 μm (available commercially as Vistafix (TP) from UCB Sidac Division) was assessed as follows. A sample of the current collector and a sample of the EAA film were positioned together such that the outer surface of the metallised multi-layer film was contacted with the surface of the EAA film. The samples were heat-sealed using a Sentinel Model 12 (Packaging Industries Group Inc) machine under the following conditions: 115° C. (top jaw) and 25° C. (lower jaw) for 10 seconds under a pressure of 50 psi. The sealed sample was cut into 25 mm wide strips and the adhesion strength was determined using an Instron Model 4464. The jaws were set 50 mm apart. The upper jaw held the EAA piece of the sealed sample and travelled up at a speed of 300 mm/min, while the lower jaw held the current collector piece of the sealed sample and was stationary. The average peel force was measured and reported as a mean value of 5 results. The plane of adhesion failure was also noted.

When the adhesion strength between the metal layer and the multi-layer film is lower than the adhesion strength (about 800 g/25 mm) between the metal layer and the EEA film, the test sample delaminates along the interface of the metal layer and multi-layer film. In this case, the average peel force represents the adhesion strength between the metal layer and the multi-layer film.

When the adhesion strength between the metal layer and the multi-layer film is higher than the adhesion strength (800 g/25 mm) between the metal layer and the EEA film, the test sample delaminates along the interface of the metal layer and EEA film.

A further plane of failure is coherent failure within the metallised layer itself, which also indicates that the adhesion strength between the metal layer and the multi-layer film is greater than the force required to achieve coherent failure (typically the adhesion strength between the metal layer and the multi-layer film is therefore greater than about 800 g/25 mm).

(viii) Delamination Resistance of the Current Collector

Delamination resistance was assessed by subjecting the current collector to elevated temperature by placing in a heated oven at that temperature, namely 5 minutes at 200° C. followed by the same time period of 5 minutes at 130° C. The adhesion strength was measured according to the method described above before and after said thermal treatment in order to assess the delamination resistance of the current collector after exposure to elevated temperature conditions which are representative of the conditions used during a typical battery manufacturing process. The delamination resistance is defined as:

$$Delamination Resistance = 100 * ( {A}_{TT} - {A}_{0} ) / {A}_{0} )$$

wherein:
A_{TT}=adhesion strength of the current collector after thermal treatment
A₀=adhesion strength of the current collector before thermal treatment

### (ix) Multi-Layer Film Thickness

The thickness of the multi-layer film, and of the heat-sealable layer(s) (A) of the multi-layer film, may be measured using a “point thickness” method. A sample of the multi-layer film having a length of about 2 cm was prepared. The thickness of the multi-layer film was measured using a Mercer gauge. Then, the heat-sealable layer(s) were dissolved and removed using a suitable solvent (for example, chloroform). The thickness of the remaining polyester substrate layer was measured using a Mercer gauge. As the skilled person would appreciate, the difference between these thickness measurements (i.e. the difference between the thickness prior to dissolving and after dissolving the heat-sealable layer(s)) provides the thickness of the heat-sealable layer(s).

(x) Molecular Weight (Mₙ and M_{w}) of the Poly(Alkylene Oxide) Glycol

GPC measurements were performed on a Malvern/Viscotek TDA 301 using an Agilent PL HFIPgel guard column plus 2×30 cm PL HFIPgel columns. A solution of HFIP with 25 mM NaTFAc was used as eluent, with a nominal flow rate of 0.8 mL min⁻¹. All experimental runs were conducted at 40° C., employing a refractive index detector. Molecular weights are referenced to polymethylmethacrylate calibrants. Data capture and subsequent data analysis were carried out using Omnisec software. Samples were prepared at a concentration of 2 mg mL⁻¹, with 20 mg of sample dissolved in 10 mL eluent. These solutions were stirred for 24 h at room temperature and then warmed at 40° C. for 30 mins to fully dissolve the polymer. Each sample was filtered through a 0.45 μm polytetrafluoroethylene membrane prior to injection.

Determination of M_{w} is made using the GPC measurement described herein.

### EXPERIMENTAL

Polyester composition P1 comprised a PET polymer having IV=0.56.

Copolyester composition P2 comprised IPA-containing PET-based copolyester (TA:IPA=82:18 mol %) having IV=0.57, Tg=74° C. and Tm=210° C.

### Example 1

A multi-layer film comprising a substrate layer of polyester composition P1 and a heat-sealable layer of copolyester P2 was extruded and cast using a standard melt coextrusion system. The coextrusion system was assembled using two independently operated extruders which fed separate supplies of polymeric melt to a standard coextrusion block or junction at which these streams were joined. From the coextrusion block, the melt-streams were transported to a conventional, flat film extrusion die. The melt temperature of polyester P1 was 275° C., and the melt temperature of copolyester P2 was 235° C. The melt curtain was cast from the common coextrusion die, and then quenched in temperature onto a rotating, chilled metal drum. The cast film was collected. The cast extrudate was stretched in the MD and TD to approximately 3.45 times its original dimensions at a temperature of 95° C. The biaxially stretched film was annealed under dimensional restraint at a temperature of 225° C. and then subjected to a first simultaneous relaxation step in both the MD and TD at −1.5% at a temperature of 225° C. for 0.9 seconds. The biaxially stretched film was then subjected to a second simultaneous relaxation step in both the MD and TD at −1.5% at a temperature of 200° C. for 1.3 seconds. Thus, the total relaxation in both the MD and TD was −3% at an average temperature of 215° C. The final multi-layer film was 6 μm in thickness and comprised two layers having an AB structure, wherein the heat-sealable copolyester layer (A) was approximately 0.73 μm thick.

A metal layer of Al having a thickness of 68 nm was then deposited on the surface of the heat-sealable copolyester layer (A), such that the current collector layer order was substrate layer (B)/heat-sealable copolyester layer (A)/first metal layer. The metal layer was deposited via thermal evaporation deposition using apparatus “BAE 370” from Balzers AG.

The thermal expansion in air at 200° C. of the film in the MD was 0.71% and in the TD was 1.08%. The sheet resistance of the current collector was measured as described herein, and was found to be 0.66 Ωsq⁻¹. Thus, the current collector advantageously achieved a sheet resistance of less than 1 Ωsq⁻¹.

Furthermore, the delamination resistance of the current collector was measured as described herein. No decrease in adhesion strength was observed. Thus, the adhesion strength of the current collector was surprisingly retained after exposure to elevated temperature, even though the overall multi-layer film, and particularly the heat-sealable copolyester layer (A), was very thin.

### Comparative Example 1

Comparative Example 1 was a mono-layer film of PET having a thickness of 6 μm. The film was stretched and relaxed in accordance with Example 1. A first and second metal layer of Al, each having a thickness of 53 nm, were then deposited on the first and second surface of the mono-layer film, such that the comparative current collector layer order was first metal layer/substrate layer/second metal layer.

The thermal expansion in air at 200° C. of the film in the MD was 0.54% and in the TD was 1.01%. The delamination resistance of the current collector was-4.7%.

The results of Example 1 and Comparative Example 1 demonstrate that the current collectors of the present invention provide surprisingly improved delamination resistance.

### Example 2

A series of multi-layer films were made in order to determine the effect of the thickness of the heat-sealable copolyester layer (A) on adhesion of the multi-layer film to itself.

Specifically, multi-layer films comprising a substrate layer of polyester composition P1 and a heat-sealable layer of copolyester P2 were extruded, cast, stretched and relaxed in accordance with Example 1. Each of the final multi-layer films comprised two layers having an AB structure, wherein the multi-layer films and the heat-sealable copolyester layer (A) had a thickness as shown in Table 1. The adhesion strength of the multi-layer film to itself was measured as described herein, and the results are shown in Table 2.

| | Thickness | Thickness | Adhesion |
|---|---|---|---|
| | of multi- | of heat- | strength |
| | layer film | sealable | to itself |
| Example | (μm) | layer (μm) | (g/25 mm) |
| Example 1 | 6 | 0.73 | 288 |
| Example 2B | 12 | 3.2 | 819 |
| Comparative 2C | 15 | 3.3 | 830 |
| Comparative 2D | 20 | 3.4 | 909 |
| Comparative 2E | 30 | 4.4 | 1053 |
| Comparative 2F | 20 | 4.6 | 1104 |

As expected, the adhesion strength of the multi-layer film to itself decreased as the thickness of the heat-sealable layer decreased. However, the multi-layer film of Example 1 and Example 2B exhibited surprisingly high adhesion strength relative to what was expected for such thin films. Furthermore, surprisingly, each of the multi-layer films and the heal-seal bonds therein were nonetheless resistant to degradation during subsequent metal deposition processes. In particular, even the very thin multi-layer film of Example 1 was able to withstand the conditions of elevated temperature during metal deposition without film damage, and good adhesion was achieved between the metal layer and the multi-layer film.

1. A current collector comprising a multi-layer film and a first metal layer, wherein the multi-layer film comprises:
(i) a polyester substrate layer (B) having a first and second surface,
(ii) a first heat-sealable layer (A1) disposed on the first surface of said polyester substrate layer,
(iii) optionally a second heat-sealable layer (A2) disposed on the second surface of said polyester substrate layer;
wherein the first heat-sealable layer (A1) and, where present, the second heat-sealable layer (A2) independently comprise at least one copolyester, wherein said first metal layer is disposed on the outer surface of the first heat-sealable layer (A1), wherein the multi-layer film has a thickness of no more than 12 μm,
wherein the total thickness of the heat-sealable layers is no more than 30% of the total thickness of the multi-layer film,
wherein the total thickness of the heat-sealable layers is the thickness of the first heat-sealable layer (A1) where the second heat-sealable layer is absent, or the thickness of the first heat-sealable layer (A1) and the second heat-sealable layer (A2) where the second heat-sealable layer (A2) is present,
wherein the first metal layer has a thickness of no more than 1000 nm, and wherein the multi-layer film exhibits an adhesion strength to itself of at least 100 g/25 mm, wherein the adhesion strength is measured according to the method in the description.

2. A current collector according to claim 1, further comprising a second metal layer, wherein the first metal layer and the second metal layer are on opposing sides of the multi-layer film, and wherein the second metal layer independently has a thickness of no more than 1000 nm.

3. A current collector according to claim 1, wherein the substrate layer (B) comprises polyethylene terephthalate or polyethylene naphthalate.

4. A current collector according to claim 1, wherein the total thickness of the multi-layer film is from 3.0 to 12 μm, preferably from 3.5 to 11.0 μm, preferably from 4.0 to 8.0 μm.

5. A current collector according to claim 1, wherein the thickness of the substrate layer (B) is from 2.0 to 11.0 μm, preferably from 2.0 to 10.0 μm, preferably from 3.0 to 7.0 μm, preferably from 4.0 to 6.0 μm.

6. A current collector according to claim 1, wherein the thickness of the substrate layer (B) is greater than the thickness of each of the first and the second heat-sealable layers (A1) and (A2).

7. A current collector according to claim 1, wherein the thickness of the substrate layer (B) is at least 75%, preferably at least 80%, and preferably no more than 99%, preferably no more than 98%, preferably no more than 95%, preferably no more than 90%, and preferably 85% of the total thickness of the multi-layer film.

8. A current collector according to claim 1, wherein the thickness of the first heat-sealable layer (A1) and, where present, the thickness of the second heat-sealable layer (A2) is each independently from 0.1 to 3.5 μm, preferably from 0.2 to 3.0 μm, preferably from 0.5 to 2.0 μm, preferably from 0.6 to 1.5 μm, preferably from 0.7 to 1.0 μm.

9. A current collector according to claim 1, wherein the copolyester of the first heat-sealable layer (A1) and, where present, the second heat-sealable layer (A2) is independently selected from copolyesters derived from at least one aliphatic diol, a first dicarboxylic acid and a second dicarboxylic acid.

10. A current collector according to claim 9, wherein the aliphatic diol is an aliphatic diol containing 2-8 carbon atoms, preferably ethylene glycol or 1,4-butanediol, preferably ethylene glycol.

11. A current collector according to claim 9, wherein the first dicarboxylic acid is an aromatic dicarboxylic acid, preferably terephthalic acid, isophthalic acid, phthalic acid and/or 2,5-, 2,6- or 2,7-naphthalene dicarboxylic acid, and preferably terephthalic acid.

12. A current collector according to claim 11, wherein the second dicarboxylic acid is an aromatic dicarboxylic acid which is different to the first dicarboxylic acid, wherein the second aromatic dicarboxylic acid is preferably terephthalic acid, isophthalic acid, phthalic acid and/or 2,5-, 2,6- or 2,7-naphthalene dicarboxylic acid, and preferably isophthalic acid.

13. A current collector according to claim 1, wherein the copolyester of the first heat-sealable layer (A1) and, where present, the second heat-sealable layer (A2) is independently selected from copolyesters derived from ethylene glycol, terephthalic acid and isophthalic acid, preferably wherein the isophthalic acid is present in an amount of from 1 to 50 mol %, preferably from 10 to 45 mol % of the acid fraction of the copolyester, such as:
(i) from 15 to 20 mol %, preferably 18 mol % of the acid fraction of the copolyester;
(ii) from 10 to 15 mol %, preferably 12 mol % of the acid fraction of the copolyester; or
(iii) from 30 to 45 mol %, preferably 40 mol % of the acid fraction of the copolyester.

14. A current collector according to claim 1, wherein the second dicarboxylic acid is an aliphatic dicarboxylic acid, wherein the aliphatic dicarboxylic acid is preferably succinic acid, sebacic acid, adipic acid or azelaic acid, and preferably azelaic acid.

15. A current collector according to claim 1, wherein the copolyester of the first heat-sealable layer (A1) and, where present, the second heat-sealable layer (A2) is independently selected from copolyesters derived from ethylene glycol, terephthalic acid and azealic acid, preferably wherein the azealic acid is present in an amount of from 10 to from 50 mol %, preferably from 30 to 48 mol %, preferably 45 mol % of the acid fraction of the copolyester.

16. A current collector according to claim 1, wherein the copolyester of the first heat-sealable layer (A1) and, where present, the second heat-sealable layer (A2) is independently selected from copolyesters derived from an aliphatic diol, a cycloaliphatic diol and at least one dicarboxylic acid.

17. A current collector according to claim 16, wherein the aliphatic diol is an aliphatic diol containing 2-8 carbon atoms, preferably ethylene glycol or 1,4-butanediol, preferably ethylene glycol, and/or wherein the at least one dicarboxylic acid is an aromatic dicarboxylic acid, preferably terephthalic acid, isophthalic acid, phthalic acid and/or 2,5-, 2,6- or 2,7-naphthalene dicarboxylic acid, and preferably terephthalic acid, and/or wherein the cycloaliphatic glycol is 1,4-cyclohexanedimethanol.

18. A current collector according to claim 16, wherein the copolyester of the first heat-sealable layer (A1) and, where present, the second heat-sealable layer (A2) is independently selected from copolyesters derived from ethylene glycol, 1,4-cyclohexanedimethanol and terephthalic acid, preferably wherein the 1,4-cyclohexanedimethanol is present in an amount of from 30 to 35 mol %, of the glycol fraction of the copolyester.

19. A current collector according to claim 1, wherein the copolyester of the first heat-sealable layer (A1) and, where present, the second heat-sealable layer (A2) is independently selected from copolyesters derived from one or more diols, one or more dicarboxylic acids and one or more poly(alkylene oxide)glycol(s).

20. A current collector according to claim 19, wherein the one or more diols is an aliphatic diol containing 2-8 carbon atoms, preferably ethylene glycol or 1,4-butanediol, preferably ethylene glycol, and/or wherein the one or more dicarboxylic acids is an aromatic dicarboxylic acid, preferably terephthalic acid, isophthalic acid, phthalic acid and/or 2,5-, 2,6- or 2,7-naphthalene dicarboxylic acid, and preferably terephthalic acid, and/or wherein the one or more poly(alkylene oxide)glycol(s) is selected from C₂ to C₁₅ alkylene chains, preferably selected from polyethylene glycol (PEG), polypropylene glycol (PPG) and poly(tetramethylene oxide)glycol (PTMO), preferably polyethylene glycol (PEG).

21. A current collector according to claim 19, wherein the copolyester of the first heat-sealable layer (A1) and, where present, the second heat-sealable layer (A2) is independently selected from copolyesters derived from ethylene glycol, terephthalic acid and polyethylene glycol, preferably wherein the polyethylene glycol is present in an amount of from 5 to from 30 wt %, preferably from 10 to 20 wt %, preferably from 10 to 15 wt %, preferably 12 wt % relative to the total weight of the copolyester in the first or second heat-sealable layer of the copolyester.

22. A current collector according to claim 1, wherein the multi-layer film is a coextruded film.

23. A current collector according to claim 1, wherein the multi-layer film is a coated film.

24. A current collector according to claim 1, wherein the multi-layer film is oriented, preferably biaxially oriented.

25. A current collector according to claim 1, wherein the thickness of the first metal layer and, where present, the second metal layer is each independently from 50 nm to 1000 nm, preferably from 100 nm to 1000 nm, preferably from 100 nm to 800 nm, preferably from 150 nm to 700 nm.

26. A current collector according to claim 1, wherein the first metal layer and, where present, the second metal layer each independently comprise at least one of aluminium, copper, nickel, titanium, silver, nickel-copper alloy, or aluminium-zirconium alloy, and preferably wherein the first and second metal layers are selected from the same material.

27. A current collector according to claim 1, wherein the first and second metal layers are both either aluminium or copper.

28. A current collector according to claim 1, wherein the adhesion strength between a metal layer and the multi-layer film is least 100 g/25 mm, preferably at least 250 g/25 mm, preferably at least 280 g/25 mm, preferably at least 300 g/25 mm.

29. A current collector according to claim 1, which exhibits a sheet resistance of from 0.01 Ωsq⁻¹ to 2.0 Ωsq⁻¹, preferably from 0.02 Ωsq⁻¹ to 2.5 Ωsq⁻¹, preferably from 0.02 Ωsq⁻¹ to 2.0 Ωsq⁻¹, preferably from 0.02 Ωsq⁻¹ to 1.5 Ωsq⁻¹, preferably from 0.05 Ωsq⁻¹ to 1.0 Ωsq⁻¹.

30. A current collector according to claim 1, wherein the current collector exhibits a breakdown current of no more than 30 A and/or a breakdown temperature of no more than 300° C.

31. A current collector according to claim 2, which further comprises at least one tab which connects the first metal layer and the second metal layer.

32. A current collector according to claim 1, wherein the multi-layer film comprises channels which extend from the first surface to the second, opposite surface thereof wherein (i) the sides of the channels are at least partially coated with at least one metal, and/or (ii) the channels are at least partially filled with at least one metal.

33. A method of manufacturing a current collector as defined in claim 1, wherein the method comprises the steps of:
(i) providing a polyester substrate layer (B);
(ii) disposing a first heat-sealable layer (A1) onto the first surface of polyester substrate layer (B);
(iii) optionally disposing a second heat-sealable layer (A2) onto the second surface of polyester substrate layer (B);
(iv) depositing a metal onto the outer surface of said first heat-sealable layer (A1) to form a first metal layer;
such that the layer order is first metal layer/first heat-sealable layer/polyester substrate layer/optional second heat-sealable layer.

34. A method according to claim 33, further comprising the step of:
(v) depositing a metal onto the second surface of polyester substrate layer (B) or, where present, onto the outer surface of said second heat-sealable layer (A2) to form a second metal layer;
such that the layer order is first metal layer/first heat-sealable layer/polyester substrate layer/second metal layer, or first metal layer/first heat-sealable layer/polyester substrate layer/second heat-sealable layer/second metal layer.

35. A method according to claim 33, wherein step (ii) and/or (iii) are effected by coextrusion.

36. A method according to claim 33, wherein step (ii) and/or (iii) are effected by coating, wherein coating comprises dispersing or dissolving the heat-sealable material in a coating vehicle to form a composition, coating the composition onto the surface of the polyester substrate layer, and then drying and optionally heating to form the heat-sealable coating layer.

37. A method according to claim 33, wherein step (iv) and/or, where present, step (v) comprises depositing the metal using thermal evaporation deposition, electron beam evaporation deposition or virtual cathode deposition.

38. (canceled)

39. A battery comprising an anode material, a cathode material, a separator between the anode material and the cathode material, an anode current collector and a cathode current collector, wherein at least one of the current collectors is a current collector as defined in claim 1.

40. A battery according to claim 39, wherein the battery is a lithium-ion battery.

41. A battery comprising an anode material, a cathode material, a separator between the anode material and the cathode material, an anode current collector and a cathode current collector, wherein the anode material is coated onto the anode current collector and wherein the anode current collector is a current collector as defined in claim 1.

42. A battery comprising an anode material, a cathode material, a separator between the anode material and the cathode material, an anode current collector and a cathode current collector, wherein the cathode material is coated onto the cathode current collector and wherein the cathode current collector is a current collector as defined in claim 1.

43. (canceled)
